(19) United States
(12) Patent Application Publication
(10) Pub. No.: US 2025/0046142 A1
(43) Pub. Date: Feb. 6, 2025

(54) SYSTEM AND METHOD FOR PROVIDING A MULTIPLE-STAGE CONTEST

(71) Applicant: CFPH, LLC, NEW YORK, NY (US)

(72) Inventors: Gregory P. Manning, New York, NY (US); Joseph C. Noviello, New York, NY (US); Howard W. Lutnick, New York, NY (US)

(21) Appl. No.: 18/926,478

(22) Filed: Oct. 25, 2024

Related U.S. Application Data
(63) Continuation of application No. 17/212,606, filed on Mar. 25, 2021.
Application No. 17/212,606 is a continuation of application No. 11/403,722, filed on Apr. 12, 2006, now abandoned.
(60) Provisional application No. 60/670,373, filed on Apr. 12, 2005.

(51) Int. Cl. G07F 17/32; G06Q 30/02

(52) U.S. Cl. CPC G07F 17/32; G06Q 30/02; G07F 17/3227; G07F 17/3248; G07F 17/3262; G07F 17/3288

(57) ABSTRACT

Contest entries eligible to win a multiple-stage contest are sold to contestants, each contest entry being defined at least by a set of one or more distinct identifiers. At each stage in the multiple-stage contest, one or more determinations regarding the distinct identifiers are made, which determinations cause a portion of the contest entries remaining eligible at that stage to become ineligible to win the contest. A market may be provided for contest entries remaining eligible after at least one of the stages. At least one winning contest entry is determined from one or more contest entries remaining eligible after the multiple stages of the contest. A competition may be held among contestants holding eligible contest entries to determine one or more winners. An award for each winning contest entry may be determined based on the revenues received from selling the plurality of contest entries.

### CROSS REFERENCE TO RELATED APPLICATIONS

This application is a continuation of U.S. patent application Ser. No. 17/212,606 filed Mar. 25, 2021, which is a continuation of U.S. patent application Ser. No. 11/403,722 filed Apr. 12, 2006, which claims priority to U.S. Provisional Patent Application No. 60/670,373 filed Apr. 12, 2005, each of which is incorporated by reference herein in its entirety.

### TECHNICAL FIELD OF THE INVENTION

This invention relates in general to contests and, more particularly, to a system and method for providing a multiple-stage contest.

### BACKGROUND OF THE INVENTION

Many states have lottery systems, by which participants purchase entries in the lottery. The money paid for the entries is pooled and a portion of the pooled money is paid to one or more winners. The one or more winners may be determined by matching randomly drawn numbers to a series of numbers on lottery tickets issued to the participants in exchange for the entry purchase price. For example, in a Lotto-style lottery, a number of balls having numbers printed thereon are mixed and one or more of the balls are then randomly selected. The number printed in the selected balls are referred to as the “winning numbers,” and lottery tickets having a minimum number of numbers that match the winning numbers are determined to be winning tickets. Awards are then given to the winning tickets, with the largest awards going to the winning ticket or tickets having the highest number of numbers that match the winning numbers.

### SUMMARY OF THE INVENTION

In accordance with the present invention, system and methods are provided for providing a multiple-stage contest.

According to one embodiment, a method of providing a multiple-stage contest is provided. At each of a plurality of stages in a contest, a portion of a plurality of contest entries eligible to win the contest are caused to become ineligible to win the contest. At least one winning contest entry is determined from one or more contest entries remaining eligible after the plurality of stages.

According to another embodiment, a method of providing a multiple-stage contest is provided. A plurality of contest entries eligible to win a multiple-stage contest are sold to a plurality of contestants, each contest entry being defined at least by a set of one or more distinct identifiers. At each stage in the multiple-stage contest, one or more determinations regarding the distinct identifiers are made, which determinations cause a portion of the contest entries remaining eligible at that stage to become ineligible to win the contest. A market may be provided for contest entries remaining eligible after at least one of the plurality of stages. At least one winning contest entry is determined from one or more contest entries remaining eligible after the multiple stages of the contest. An award for each winning contest entry may be determined based on the revenues received from selling the plurality of contest entries.

Various embodiments of the present invention may benefit from numerous advantages. It should be noted that one or more embodiments may benefit from some, none, or all of the advantages discussed below.

One advantage of the invention is that systems and methods are provided for providing a multiple-stage contest. Any number of contest entries eligible to win the multiple-stage contest may be sold to any number of contestants, and the contest may be regional, national, or in some cases, international. A portion of the contest entries are eliminated from competition at each of a number of stages, which may occur over any desired period of time. In some embodiments, markets may be provided for buying, selling, or otherwise exchanging eligible contest entries between each of the stages, which may create additional interest or excitement regarding the contest.

After the number of eligible contest entries has been reduced to a particular number, the owners, or the remaining eligible contest entries (or delegates assigned by the owners) may then compete in various competitions and/or voting in order to determine one or more winning contest entries or contestants. In this regard, the selection process for a first stage of the multiple-stage contest may be different from the selection processes for subsequent stages of the multiple-stage contest. Such competitions and/or voting may be broadcast to the public (such as via television, radio, or the Internet), thus creating further interest or excitement regarding the contest. In addition, the public may affect the outcome of the contest, such as by telephone or online voting.

Other advantages will be readily apparent to one having ordinary skill in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates an example system for providing a multiple-stage contest;

FIGS. 2A-2B illustrate example contest entries for use in a multiple-stage contest provided by the system shown in FIG. 1;

FIG. 3 illustrates a multiple-stage process of reducing the number of eligible contest entries according to one embodiment of the invention; and

FIG. 4 is a flowchart illustrating an example method of managing a multiple-stage contest in accordance with one embodiment of the invention.

### DETAILED DESCRIPTION OF THE DRAWINGS

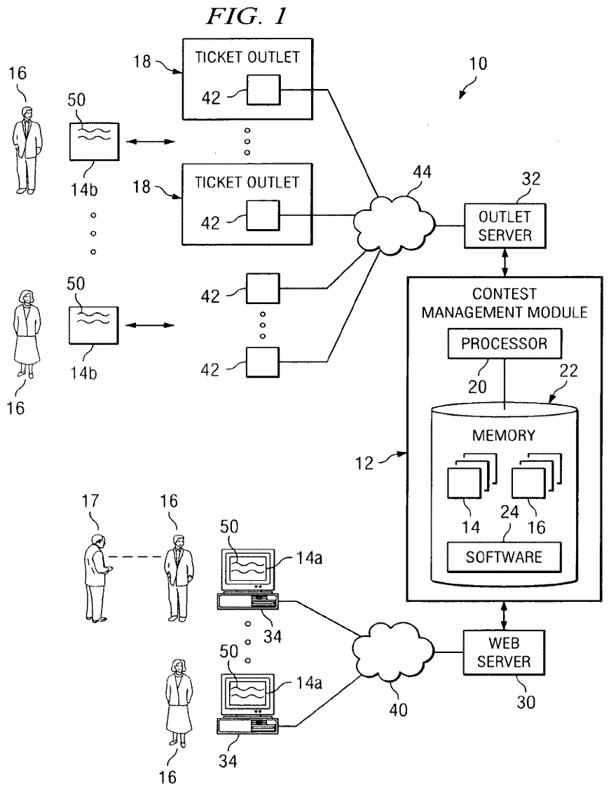

Example embodiments of the present invention and their advantages are best understood by referring now to FIGS. 1 through 4 of the drawings, in which like numerals refer to like parts. In general, according to at least some embodiments, systems, and methods for providing a multiple-stage contest are provided. A number of contest entries eligible to win the multiple-stage contest may be sold to a number of contestants. Each contest entry may comprise a ticket (either physical or electronic) and may be defined by a set of one or more distinct identifiers (such as one or more numbers or alphanumeric characters, for example) located on the ticket. At each stage of the multiple-stage contest, one or more determinations regarding the distinct identifiers are made, which determinations cause a portion of the contest entries having remained eligible until that stage to become ineligible to win the contest. For example, in embodiments in which each ticket has one or more numbers printed thereon, a numerical determination may be made at each stage that causes a portion of the contest entries remaining eligible at that stage to become ineligible to win the contest. In some embodiments, such determinations may be broadcast, such as via the Internet, television, or radio, and in some cases may be broadcast live or substantially in real-time.

In another example, the distinct identifiers associated with the tickets may form an association between a contestant possessing a ticket and a particular participant in an underlying event (e.g., a golfer in a tournament, a football team in a game, a politician in an election, a contestant in a television show, etc.). Any of a series of outcomes associated with the underlying event causes a portion of the contest entries to become ineligible to win the contest. For example, if a particular golfer failed to make the cut at a golf tournament, then all of the contestants possessing tickets associated with that golfer may become ineligible to win the contest. Other examples from other sporting events, political events, entertainment events, or any other daily events may be used to make entries ineligible to advance through one or more of a series of stages in the multi-stage contest.

After the multiple stages of the contest, a set of one or more contest entries remain eligible to win the contest. At least one winning contest entry is determined from this set of one or more remaining contest entries. In some embodiments, each of the one or more contest entries that have remained eligible to win the contest throughout the multiple stages of the contest is determined to be a winning contest entry. In other embodiments, a secondary contest among the set of contest entries remaining eligible to win is performed in order to determine at least one winning contest entry from the set of remaining contest entries. Such secondary contest may include one or more competitions between contestants owning or otherwise associated with the set of remaining contest entries. Such competitions may include mental, physical, or other competitions between the remaining contest ants. In some embodiments, the competitions between contestants may include voting among the contestants and/or non-contestants, such as the general public, in order to further eliminate remaining contest entries (or associated contestants) or to determine one or more winning contest entries (or associated contestant(s)).

In particular embodiments, the secondary contest may be broadcast, such as via the Internet, television, or radio, and in some cases may be broadcast live or substantially in real-time. For example, the secondary contest may be a “reality-based” television show in which the remaining contestants participate in various contests and/or voting against each other to determine one or more winning contestants.

A monetary or other type of award may be provided to each winning contestant. In the case of monetary awards, the amount of the awards may be determined from an award pool including at least a portion of the revenues collected from the original selling of contest entries. In some cases, the award pool may also include a portion of the revenues generated by broadcasting the secondary contest. A commission for providing and managing the contest may be determined and removed from the award pool. The commission may be a particular monetary amount or a particular percentage of the award pool. Awards may be provided to winning contestants in any suitable manner, such as lump-sum cash awards or a number of installment payments over a period of time, for example.

Based on the operation of the multiple-stage contest, the value of contest entries remaining eligible to win the contest naturally increases as the contest progresses (i.e., as the number of contest entries remaining eligible to win the contest decreases). In some embodiments, markets may be provided for buying and selling contest entries remaining eligible after at least one of the multiple stages of the contest and/or during the secondary contest. Such markets may include all forms and variations of electronic markets and/or physical markets for the exchange of remaining eligible contest entries, which may include all forms and variations of auction markets. In addition, markets may be provided for wagering on particular results of the contest, such as wagering on particular remaining contestants to win the contest or a stage of the contest, for example.

FIG. 1 illustrates an example system 10 for providing a multiple-stage contest according to an embodiment of the present invention. As shown, system 10 may include a contest management module 12 operable to provide one or more contest entries 14 to one or more contestants 16 and/or to manage a multiple-stage contest for such contest entries 14. Contest management module 12 may provide contest entries 14 to contestants 16 in any suitable manner. Further, contest management module 12 may provide contestants 16 either or both electronic contest entries 14a and/or physical contest entries 14b (e.g., paper ticket). For example, in the embodiment shown in FIG. 1, contest management module 12 may provide contestants 16 (a) electronic contest entries 14a via the Internet and (b) physical contest entries 14b via one or more ticket outlets 18. Thus, contest management module 12 may be associated with or comprise one or more web servers 30 operable to provide a web interface for providing electronic contest entries 14a to contestants 16 via the Internet and/or one or more outlet servers 32 operable to communicate with ticket outlets 18 such that ticket outlets 18 may provide physical contest entries 14b (e.g., paper tickets) to contestants 16.

Contest management module 12 may communicate with contestants 16, such as to provide an interface for contestants to buy and/or sell electronic contest entries 14a, via user terminals 34 coupled to one or more web servers 30 via a first communications network 40. Similarly, contest management module 12 may communicate with ticket outlets 18, such as to provide an interface for ticket outlets 18 to sell physical contest entries 14b to contestants 16, via ticket terminals 42 (located at or otherwise associated with ticket outlets 18) coupled to one or more outlet servers 32 via a second communication ns network 44.

Content management module 12 may also provide a platform for a secondary market in which eligible contest entries 14 may be bought, sold, or otherwise transacted at one or more stages of the multi-stage contest. Such a secondary market may be based upon a bid/offer transaction, an auction transaction, an option transaction, or any of a variety of other suitable market-based transactions whether now known or hereinafter developed. The particular type of transaction that can be conducted may be the same or different at any given stage 12 of the multi-stage contest. Any number and combination of the various elements of system 10, such as, for example, processor 20 and memory 22 of module 12, servers 30 and 32, communications networks 40 and 44, and user terminals 34 may be used to support the secondary market transactions of system 10. Moreover, any of these components may couple to and/or operate in conjunction with components of any other systems that support market based transactions, in order to provide the secondary market transactions of system 10.

In a particular aspect of operation, user terminals 34 may include a display that provides information to support transacting contest entries 14. Examples of this information may include, without limitation, the contest entries 14 that are available for transaction, the value and/or price of these contest entries 14, the contestants 16 associated with these contest entries 14, and any other suitable information.

In a further embodiment, commission fees and/or transaction fees may be charged for transactions conducted in the secondary market for contest entries 14. The amounts of such fees may depend, for example, on the size of the transaction, the stage of the contest at which the transaction is being conducted, or upon any other suitable criteria. In this regard, revenue may be generated from transaction fees associated with the secondary market for contest entries 14.

Contest management module 12 may comprise an at least partially computerized system for providing and/or managing a multiple-stage contest as described herein. Contest management module 12 may include a computer, a server, a management center, a single workstation, or a headquartering office for any person, business, or entity that provides and/or manages a multiple-stage contest. Accordingly, contest management module 12 may include any suitable hardware, software, personnel, devices, components, elements, or objects that may be utilized or implemented to achieve the operations and functions described herein.

As shown in FIG. 1, contest management module 12 may include a processing unit 20 and a memory unit 22. Processing unit 20 may process data associated with contest entries 14, contestants 16, designees 17, various determinations made at each stage regarding the elimination of contest entries 14, secondary market transactions, or any other relevant data, which may include executing software 24 or other coded instructions that may in particular embodiments be associated with contest management module 12. Memory unit 22 may store software 24, data associated with contest entries 14, contestants 16, designees 17, determinations made at each stage regarding the elimination of contest entries 14, secondary market transactions, and any other relevant data. Memory unit 22 may be coupled to data processing unit 20 and may include one or more databases and other suitable memory devices, such as one or more random access memories (RA.Ms), read-only memories (ROMs), dynamic random access memories (ORA.Ms), fast cycle RAMs (FCRA.Ms), static RAM (SRA.Ms), field-programmable gate arrays (FPGAs), erasable programmable read-only memories (EPROMs), electrically erasable programmable read-only memories (EEPROMs), or any other suitable volatile or non-volatile memory devices.

It should be understood that the functionality provided by contest management module 12 may be partially or completely manual such that one or more humans may provide various functionalities associated with contest management module 12. For example, a human agent and/or processor 20 of contest management module 12 may facilitate the determinations made at each stage that eliminate a portion of the remaining eligible contest entries 14.

It should also be understood that although FIG. 1 illustrates a particular embodiment of the invention, some or all of the various automated functionalities provided by system 10 discussed herein may be provided by any suitable hardware, software, or other computer devices located at, hosted by, or otherwise associated with any one or more components of system 10, including user workstations 34, ticket terminals 42, first communications network 40, second communications network 44, web servers 30 and/or outlet servers 32. Moreover, the various functionalities described above with regard to module 12 may be distributed in whole or in part among any suitable number, combination, and arrangement of modules 12.

Contest entries 14 comprise entries to win a multiple-stage contest provided by system 10 as described herein. Each contest entry 14 may be owned by, or otherwise associated with, one or more contestants 16. For example, an individual, a group of individuals, or firm may purchase a particular contest entry 14. As discussed above, contest entries may include electronic contest entries 14a and/or physical contest entries 14b. Electronic contest entries 14a may include contest entries 14 embodied in electronic media, and thus may be provided, purchased, sold, or otherwise managed via electronic means, such as a computer network including contest management module 12, web server 30 and user terminals 34 coupled via first communications network 40. In some embodiments, a contestant 16 may print a paper version of an electronic contest entry 14a, such as using a printer associated with a user terminal 34, for example. Physical contest entries 14b may include contest entries 14 embodied in a physical medium, such as a paper ticket, for example. In some embodiments, physical contest entries 14b may be provided and sold to contestants 16 at ticket outlets 18. For example, a ticket outlet 18 may print out ticket entries 14b purchased by contestants 16 using a ticket terminal 42, as discussed below in greater detail.

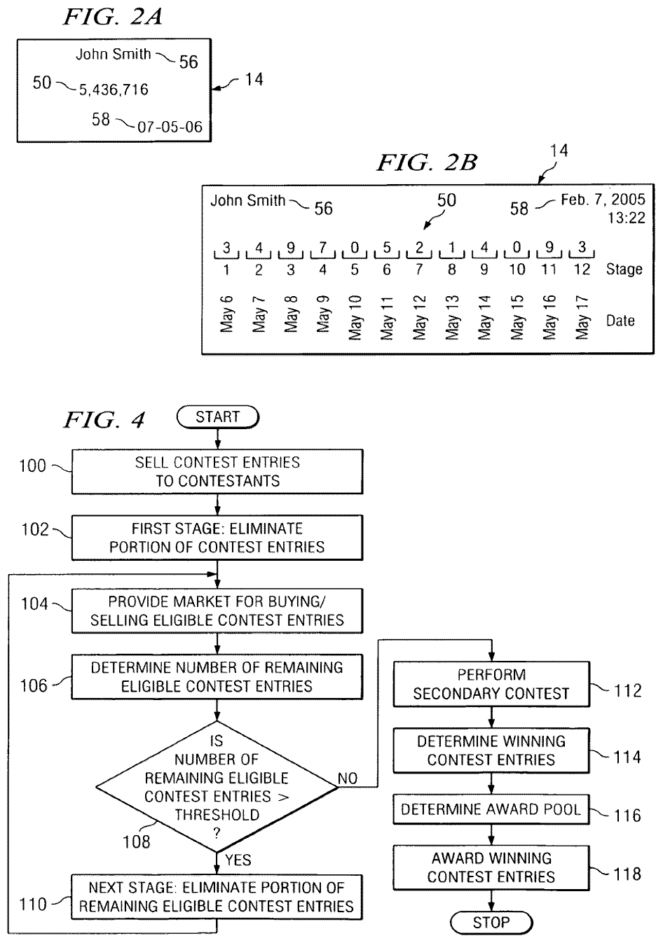

Contest entries 14 may be defined by a set of one or more distinct identifiers 50, such as one or more numbers, alphanumeric characters, words, shapes, designs, colors, or any other distinct features. As discussed in greater detail below with reference to FIGS. 2-4, the set of distinct identifiers 50 defining each contest entry 14 may be used to determine whether that contest entry 14 remains eligible to win the contest after each stage of the contest. As discussed below, determinations made at each stage of the contest may eliminate, based on the set of distinct identifiers 50 defining each contest entry 14, a portion of the contest entries 14 remaining eligible to win the contest.

The set of distinct identifiers 50 defining a contest entry 14 may be located on the contest entry 14 itself. For example, the set of distinct identifiers 50 defining a ticket entry 14b may be printed on the face of the ticket. As another example, the set of distinct identifiers 50 defining an electronic contest entry 14a may be displayed in association with an image of a ticket via a monitor or other display.

A contestant 16 may include any entity that may purchase or own a contest entry 14, such as an individual, a group of individuals, a firm, a legal entity, or any other suitable entity. In some embodiments, a designee 17 includes an individual or group of individuals designated to act on behalf of a contestant 16 or any other entity that owns a contest entry 14. For example, a particular individual may own a contest entry 14, but designate another individual to participate in one or more aspects of a multiple-stage contest. Thus, supposing a multiple-stag e contest includes one or more mental or physical competitions between contestants 16, an owner of an eligible contest entry 14 may designate another individual or entity to participate in such competitions in connection with the owner's eligible contest entry 14. Such a designation may be memorialized by a written contract or by some other official process that is recognized and acknowledged by system 10.

In particular embodiments, the right to be a designee 17 for a particular competition between contestants 16 may be auctioned using one or more components of system 10. In these embodiments, one or more individuals, groups or other entities may bid in an auction on the right to participate in a competition on behalf of a particular contestant 16. The winning bidder would then pay the contestant 16 a fee in exchange for the right to participate in the competition and/or the right to a portion of any award distributed to the contestant 16 based upon the outcome of one or more aspects of the multi-stage contest. The processor 20 may facilitate and coordinate the operation of this auction process. Memory 22 may store data associated with designees 17 and/or information memorializing the designation.

For example, if one of the competitions in the multi-stage contest comprises a bowling contest, then a contestant 16 may auction the right to participate in that bowling contest to some portion of the public. The winning bidder in that auction may pay the contestant 16 a sum of money, such as $2,000, in exchange for the right to participate in the bowling contest and further in exchange for some percentage, such as 10%, of the award distributed to the contestant 16, if any, at the end of the multiple-stage contest. In this regard, the contestant 16 is able to auction off some portion of the value of an award that may be distributed to that contestant 16 in exchange for obtaining a fee and the services of a designee 17 to participate in a particular competition on behalf of the contestant 16. This may be advantageous for the contestant 16, for example, in those cases where the contestant 16 is not as skilled in the competition at hand as the winning bidder of the auction.

The winning bidder of the auction need not be the bidder that bid the highest amount in the auction. The winning bidder may be chosen by the contestant 16 based on any suitable combination of the fee the bidder is willing to pay, the percentage of the award that the bidder is willing to take, and the skill level of the bidder in the particular competition at hand.

As discussed above, in some embodiments, electronic contest entries 14a may be provided, purchased, sold, or otherwise managed via a computer network including contest management module 12, one or more web servers 30 and one or more user terminals 34 coupled via first communications network 40. Web servers 30 associated with contest management module 12 may store websites and/or website information in order to host one or more web pages. Web servers 30 may be coupled to first communication network 40 and may be partially or completely integrated with, or distinct from, contest management module 12 and/or outlet servers 32.

A user terminal 34 may include a computer system and appropriate software to allow an individual or group of individuals to perform various functions related to a multiple-stage contest, such as purchasing and/or selling contest entries 14 and viewing the progress of the multiple-stage contest, for example. As used in this document, the term “computer” refers to any suitable device operable to accept input process the input according to predefined rules, and produce output, for example, a personal computer, workstation, network computer, wireless data port, wireless telephone, personal digital assistant, one or more processors within these or other devices, or any other suitable processing device. A user terminal 34 may include one or more human interfaces, such as a mouse, keyboard, or pointer, for example.

A user terminal 34 may include a browser application operable to provide an interface to the web pages hosted by web servers 30 such that contestants 16 may communicate information to, and receive information from, contest management module 12 via first communication network 40. In particular, the browser application may allow a contestant 16 to navigate through, or “browse,” various Internet web sites or web pages hosted by a web server 30 to provide an interface for communications between the contestant 16 and contest management module 12. For example, one or more web pages may provide a contestant 16 an interface to access, purchase, and/or exchange contest entries 14, determine the status (i.e., eligible, or ineligible to win the relevant contest) of particular contest entries 14, or to otherwise participate in a multiple-stage contest.

First communications network 40 is a communicative exchange operable to exchange data or information (including, for example, data regarding contest entries 14 and various other messages) between user terminals 34 and contest management module 12. In a particular embodiment, first communications network 40 represents an Internet architecture. However, first communications network 40 may include any local area network (LAN), metropolitan area network (MAN), wide area network (WAN), wireless local area network (WLAN), virtual private network (VPN), intranet, plain old telephone system (POTS), or any other appropriate architecture or system that facilitate s communications in a network or telephonic environment.

Ticket outlets 18 may include any location or entity, that may sell contest entries 14, such as ticket entries 14b, to contestants 16. Ticket outlets 18 may include merchants of goods or services, such as grocery or convenience stores, for example. In some embodiments, ticket outlets 18 may include ticket terminals 42 operable to generate and/or print out contest entries 14 (e.g., ticket entries 14b) for sale to contestants 16. As discussed above, ticket terminals 42 may be communicatively coupled to one or more outlet servers 32 via a second communications network 44 such that contest management module 12 may manage the contest entries 14 being sold to contestants 16.

Ticket terminals 42 may include any apparatus, such as one or more computers, that generate and/or print out contest entries 14 for sale to contestants 16.

Contest management module 12 may determine one or more details of contest entries 14 generated by ticket terminals 42, such as the type of contest entry 14 and/or at least a portion of the set of distinct identifiers 50 defining the particular contest entry 14. In some embodiments, prospective contestants 16 may select one or more details of contest entries 14 generated by ticket terminals 42, such as the type of contest entry 14 and/or at least a portion of the set of distinct identifiers 50 defining the particular contest entry 14. For example, a prospective contestant 16 may select a personally desired set of distinct identifiers 50 for a contest entry 14. A sales associate (or the prospective contestant 16 himself or herself) may then enter the selected set of distinct identifiers 50 into a ticket terminal 42, which may then generate and print out a ticket entry 14b for the contestant 16.

In some embodiments, ticket terminals 42 may include stand-alone ticket terminals 42, which may or may not be associated with ticket outlets 18. Stand-alone ticket terminals 42 may provide a direct interface for a prospective contestant 16 to purchase contest entries 14. Stand-alone ticket terminals 42 may be similar in form to automated teller machines, stand-alone Internet terminals, or terminals or kiosks used for direct purchase of various merchandise, such as calling cards, for example. Stand-alone ticket terminals 42 may allow a prospective contestant 16 to select one or more details of contest entries 14 generated by ticket terminals 42, such as the type of contest entry 14 and/or at least a portion of the set of distinct identifiers 50 defining the particular contest entry 14, as discussed above.

As discussed above, contest management module 12 may communicate with ticket outlets 18 and/or ticket terminals 42 coupled to one or more outlet servers 32 via a second communications network 44 in order to provide contest entries 14 (e.g., ticket entries 14b) to contestants 16. In some embodiments, outlet servers 32 associated with contest management module 12 would store websites and/or website information 50 in order to host one or more web pages 52, which may be accessed via ticket terminals 42. Outlet servers 32 may be partially or completely integrated with, or distinct from, contest management module 12 and/or web servers 30.

Second communications network 44 is a communicative exchange operable to exchange data or information (including, for example, data regarding contest entries 14 and various other messages) between ticket terminals 42 and contest management module 12. In a particular embodiment, second communications network 44 represents an Internet architecture. However, like first communications network 40, second communications network 44 may include any local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment. Moreover, networks 40 and 44 may or may not overlap in whole or in part.

FIGS. 2A-2B illustrate example contest entries 14 in a multiple-stage contest provided by system 10. The contest entries 14 illustrated in FIGS. 2A-2B may be either electronic contest entries 14a or physical contest entries 14b. As discussed above, each contest entry includes a set of one or more distinct identifiers 50 that defines that particular contest entry 14. In some embodiments, the set of one or more distinct identifiers 50 defining each particular contest entry 14 is unique from each other contest entry 14. In other embodiments, more than one contest entry 14 may have a similar or identical set of distinct identifiers 50. In addition, each contest entry 14 may include other information, such as the name 56 of the contestant 16 owning or associated with the contest entry 14, as well as the date and/or time 58 that the contest entry 14 was purchased by the contestant 16.

In the embodiment shown in FIG. 2A, the set of one or more distinct identifiers 50 defining the contest entry 14 includes a single, multi-digit number, which may be unique from that of each other contest entry 14. The single, multi-digit number may be manually selected by the contestant 16 or electronically determined by a component of system 10 (such as contest management module 12 or a ticket terminal 42, for example), depending on the particular embodiment. In an embodiment in which such contest entries 14 are used, the determinations made at each stage to eliminate a portion of the remaining eligible contest entries 14 may include, for example, determining particular ranges of numbers (i.e., distinct identifiers 50) that remain eligible to win the contest or that are eliminated from eligibility.

For example, the distinct identifier 50 defining the particular contest entry 14 shown in FIG. 2A is “5,435,716.” At each stage in the multiple-stage contest, the range of numbers (i.e., distinct identifiers 50) that remain eligible to win the contest may be further reduced. For instance, it may be determined at the first stage that the range of numbers from 4,000,000 to 8,000,000 remain eligible, resulting in the particular contest entry 14 remaining eligible. It may then be determined at the second stage that the range of numbers from 4,200,000 to 6,200,000 remain eligible, resulting in the particular contest entry 14 remaining eligible. It may then be determined at the third stage that the range of numbers from 4,400,000 to 5,400,000 remain eligible, resulting in the particular contest entry 14 being eliminated from competition (i.e., becoming ineligible to win the contest).

In the embodiment shown in FIG. 2B, the set of one or more distinct identifiers 50 defining the contest entry 14 includes a series of twelve numerical digits, each digit located in a position corresponding to one of a plurality of stages in the multiple-stage contest. A date corresponding to each stage may be included on the contest entry 14 to provide an easy reference to the contestant 16. To illustrate, the example contest entry 14 shown in FIG. 2B includes the series of digits [3, 4, 9, 7, 0, 5, 2, 1, 4, 0, 9, 3], each digit corresponding to one of twelve stages in a multiple-stage contest. Further, the date for each of such twelve stages is listed below each corresponding digit. The multiple digits (in this example, the twelve digits) may be manually selected by the contestant 16 or electronically determined by a component of system 10 (such as contest management module 12 or a ticket terminal 42, for example), depending on the particular embodiment.

In an embodiment in which such contest entries 14 are used, at each stage, one or more determinations may be made regarding the identifier 50 (in this example, the numerical digit) located in the position corresponding to that stage in order to eliminate (i.e., make ineligible) a portion of the contest entries 14 remaining eligible at that stage. For example, it may be determined at the first stage that only contest entries 14 having one or more particular digits in the first position remain eligible. The one or more particular digits may be determined or selected in any suitable manner, such as randomly or according to a particular algorithm, for example. In this example, if the one or more particular digits includes the digit “3,” the example contest entry 14 shown in FIG. 2B would remain eligible (since the example contest entry 14 has an identifier of “3” in the first position corresponding to the first stage). It may then be determined at the second stage that only contest entries 14 having one or more particular digits in the second position remain eligible. Thus, in this example, if the one or more particular digits includes the digit “4,” the example contest entry shown in FIG. 2B would remain eligible (since the example contest entry 14 has an identifier of “4” in the second position corresponding to the second stage). This process may repeat for each stage of the contest. Although FIGS. 2A and 2B illustrate particular examples of contest entries 14 and identifiers 50, any suitable type of entries 14 and identifiers 50 may be used without departing form the scope of this disclosure. Moreover, although FIGS. 2A and 2B are described with reference to a particular technique for determining which contest entries 14 remain eligible from stage to stage of the multiple stage contest, any other suitable techniques for making these determinations are within the scope of this disclosure (e.g., determinations based on odd or even numerical characters, determinations based on ranges of alphanumeric characters, etc.).

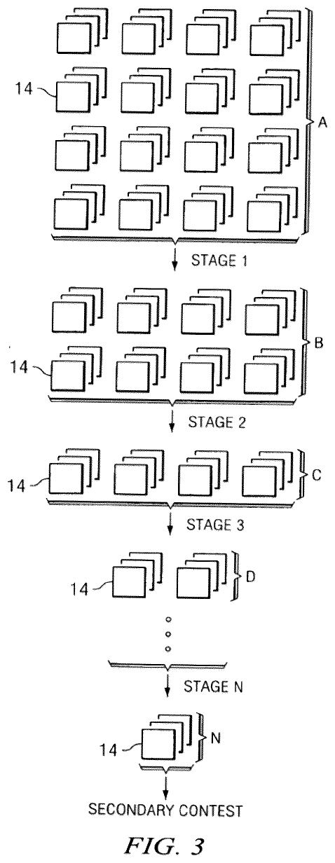

FIG. 3 illustrates a multiple-stage process of eliminating eligible contest entries 14 according to one embodiment of the invention. A number of contest entries 14 eligible to win the contest are purchased by various contestants 16 prior to the start of the multiple-stag e contest, indicated in FIG. 3 as group A of contest entries 14. As discussed above, each contest entry 14 includes a set of one or more distinct identifiers 50 that define that contest entry 14.

At the first stage of the contest (Stage 1), one or more first determinations are made regarding the distinct identifiers 50 associated with the contest entries 14, such first determinations eliminating at least a portion of the contest entries 14 in group A from being eligible to win the contest, based at least on the distinct identifiers 50 defining each of the contest entries 14 in group A. The contest entries 14 remaining eligible after the determinations at Stage 1 are indicated in FIG. 3 as group B of contest entries 14.

At the second stage of the contest (Stage 2), which occurs at some point after Stage 1, one or more second determinations are made regarding the distinct identifiers 50 associated with the contest entries 14, such second determinations eliminating at least a portion of contest entries 14 in group B from being eligible to win the contest, based at least on the distinct identifiers 50 defining each of the contest entries 14 in group B. The contest entries 14 remaining eligible after the determinations at Stage 2 are indicated in FIG. 3 as group C of contest entries 14.

At the third stage of the contest (Stage 3), which occurs at some point after Stage 2, one or more third determinations are made regarding the distinct identifiers 50 associated with the contest entries 14, such third determinations eliminating at least a portion of contest entries 14 in group C from being eligible to win the contest, based at least on the distinct identifiers 50 defining each of the contest entries 14 in group C. The contest entries 14 remaining eligible after the determinations at Stage 3 are indicated in FIG. 3 as group D of contest entries 14.

This process may continue until Stage N, after which a group of one or more contest entries 14 indicated in FIG. 3 as group N remain eligible. In some embodiments, each contest entry 14 in group N is determined a winning entry and provided an award. In other embodiments, the contest entries 14 in group N advance to a secondary portion of the multiple-stage contest, which may include various competitions and/or voting between contestants 16 that own or are otherwise associated with the contest entries 14 in group N. Such secondary portion of the multiple-stage contest is described in greater detail below with reference to FIG. 4.

The one or more determinations made at each stage (Stage 1 through Stage N) may eliminate a predetermined number, percentage, or portion of the contest entries 14 remaining eligible at that stage. The determinations made at each stage may be designed to eliminate the same number, percentage, or portion of eligible contest entries 14, or different numbers, percentages, or portions of eligible contest entries 14. In particular embodiments, the determinations made at each stage eliminate approximately one-half (or 50%) of the contest entries 14 remaining eligible at that stage.

In the foregoing example, a portion of eligible contest entries 14 are eliminated at successive stages of a multiple-stage contest. According to certain embodiments, a contest may be divided into stages wherein each stage may be won separately. In particular, each stage of a contest may be associated with an award that is separate from the awards of other stages of the contest. For a particular stage of a contest, one or more determinations may be made regarding contest entries 14 to determine one or more winning contestants 16 for that particular stage. Winning contestants 16 for a given stage may receive all or a portion of the award associated with that stage of the contest. This method may be repeated for each stage of a contest. According to certain embodiments, for a contest consisting of N stages, a particular contestant 16 may have N chances to win an award.

An example illustrates certain embodiments of the present invention. A lottery may be divided into three stages—a morning stage, an afternoon stage, and an evening stage. The morning stage may be associated with a first award, the afternoon stage may be associated with a second award, and the evening stage may be associated with a third award. For the morning stage, one or more determinations may be made regarding contest entries 14 to determine one or more winning contestants 16. The winning contestants 16 of the morning stage may receive all or a portion of the first award associated with the morning stage. The lottery may then proceed to the afternoon stage, wherein one or more determinations may be made regarding contest entries 14 to determine one or more winning contestants 16 for that stage. The winning contestants 16 of the afternoon stage may receive all or a portion of the second award associated with the afternoon stage. This method may be repeated again for the evening stage of the lottery.

According to certain embodiments, the winning contestants 16 of one stage of a contest may be determined differently than the winning contestants 16 of another stage of the contest. For example, a winning contestant 16 of one stage of a contest may be determined based on random selection of distinct identifiers 50 associated with contest entries 14 while a winning contestant 16 of another stage of the contest may be determined based on the performance of participants in an underlying competition, the participants associated with contest entries 14. It will be understood that any number or combination of determinations regarding contest entries 14 may be used to determine a winning contestant 16 of a stage of a contest. According to certain embodiments, a plurality of multiple-stage contests may be conducted simultaneously.

Although the foregoing example describes a lottery divided into three stages, it will be understood that a lottery or other contest may be divided into any number and combination of stages. According to certain embodiments, the stages of a multiple-stage contest may share a common award pool. In other embodiments, each stage of a contest may be associated with a separately maintained award pool. Thus, the award pool for each stage of a multiple-stage contest may be maintained and won separately.

FIG. 4 illustrates an example method of managing a multiple-stage contest in accordance with one embodiment of the invention. At step 100, during a period prior to the beginning of the multiple-stage contest, contest entries 14 are sold to contestants 16 in any suitable manner. For example, electronic contest entries 14a may be sold to contestants 16 via user terminals 34 and physical contest entries 14b (e.g., tickets) may be sold to contestants 16 via ticket outlets 18 and/or ticket terminals 42, such as described above.

At step 102, at the first stage of the multiple-stage contest, one or more first stage determinations are made regarding the distinct identifiers 50 associated with the purchased contest entries 14. The first stage determinations may eliminate, based at least on the distinct identifiers 50 defining each of the contest entries 14, at least a portion of the contest entries 14 from being eligible to win the contest. For example, in an embodiment in which the type of example contest entry shown in FIG. 2B is used, the first stage determinations may be a determination that only contest entries 14 having an odd-numbered digit in the position corresponding to the first stage (e.g., the first position) remain eligible. The first stage determinations may be made and/or managed by contest management module 12, and may be made randomly or in any other suitable manner. For example, balls having different digits printed thereon may be mixed and selected randomly (such as using a Lotto machine) in order to make the first stage determinations. The first stage determinations, or at least the results of the first stage determinations, may be broadcast, such as by television, radio, or the Internet (or other computer network), for example. In some embodiments, the first stage determinations may be broadcast live or substantially in real time.

At step 104, system 10 may provide any suitable market for buying, selling, or otherwise trading contest entries 14 still remaining eligible to win the contest. In some embodiments, contest management module 12 may provide an electronic market (e.g., via the Internet) allowing various parties, which may include current contestants 16 as well as non-contestants, to buy, sell or otherwise trade eligible contest entries 14. In particular embodiments, contest management module 12 may provide an electronic auction market, such that contestants 16 that own eligible contest entries 14 may auction their contest entries 14 to any portion of the public. In some embodiment s, contest management module 12 may use web servers 30 to provide market participants access to web pages providing an interface to participate in the market for eligible contest entries 14. Individuals or groups of individuals may use user terminals 34 or any other device communicatively coupled to first communications network 40 to participate in such electronic market. Details regarding transactions of eligible contest entries 14 may be recorded by contest management module 12, such as the price, the time of the transaction, the type of the transaction, the identity of the selling party (i.e., the former contestant 16), and the identity of the purchasing party (i.e., the new contestant 16), and the identity of any designees 17. Thus, a record of the contestant 16 (or owner) associated with each eligible contest entry 14 may be stored.

In some embodiments, eligible contest entries 14 may be otherwise exchanged (e.g., sold and purchase d) between various parties. For example, one party may sell an eligible contest entry 14 to another party for cash or other consideration. In some embodiments, such non-electronic transactions may be recorded in a suitable manner such that contest management module 12 may keep track of the current owner of each eligible contest entry 14. For example, a party who purchases an eligible contest entry 14 from another party may record the transaction, and thus their new ownership of the eligible contest entry 14, with contest management module 12 by submitting relevant information to contest management module 12 electronically (via a user terminal 34) or at a ticket outlet 18 or ticket terminal 42.

At step 106, contest management module 12 may determine the number of contest entries 14 remaining eligible at that particular stage. Since contest management module 12 may keep a record of the distinct identifiers 50 associated with each purchased contest entry 14, contest management module 12 may determine which contest entries 14 remain eligible, and thus the number of contest entries 14 remaining eligible.

In some embodiments, once the number of remaining eligible contest entries 14 is reduced below a particular threshold, the remaining eligible contest entries 14 are advanced to a secondary portion of the contest, which may involve various competitions and/or voting among contestants 16 associated with the eligible contest entries 14. Thus, at step 108, contest management module 12 may determine whether the number of remaining eligible contest entries 14 determined at step 104 exceeds a predetermined threshold number. If the number of remaining eligible contest entries 14 is less than or equal to the predetermined threshold number, the remaining eligible contest entries 14 are advanced to a secondary portion of the contest at step 112, which step is described in greater detail below.

However, if the number of remaining eligible contest entries 14 is greater than the predetermined threshold number, the method continues to the next stage of the multiple-stage contest at step 110. At step 110, one or more determinations are made regarding the distinct identifiers 50 associated with contest entries 14 in order to further eliminate a portion of the remaining eligible contest entries 14. Such determinations may be similar to those made at the first stage, discussed above at step 102. For ex ample, in an embodiment in which the type of example contest entry shown in FIG. 2B is used, it may be determined at the second stage that only contest entries 14 having an even-numbered digit in the position corresponding to the second stage (e.g., the second position) remain eligible. As discussed above, such determinations, or at least the results of such determinations, may be broadcast, such as by tele vis ion, radio, or the Internet (or other computer network), for example. In some embodiments, the determinations may be broadcast live or substantially in real time.

The method may then return to repeat steps 104-110 for a number of stages until it is determined at step 108 that the number of remaining eligible contest entries 14 is less than or equal to the predetermined threshold number, at which point the remaining eligible contest entries 14 are advanced to a secondary portion of the contest at step 112, as discussed above.

At step 112, the remaining contest entries 14 advance to a secondary portion of the contest, which may involve various competitions and/or voting among contestants 16 associated with the eligible contest entries 14. Such competitions may include mental, physical, or other competitions between the remaining contestants 16 and/or their designees 17. In some embodiments, the competitions between contestants 16 may include voting among the contestants 16 and/or non-contestants, such as the general public, in order to further eliminate remaining contest entries 14 (or associated contestants 16) or determine one or more winning contest entry 14 (or winning contestant 16). The right to be a designee 17 for a particular competition between contestants 16, as described in greater detail above, may be auctioned at step 112 as well.

In particular embodiments, the secondary contest may be broadcast, such as via television, radio, or the Internet, and in some cases may be broadcast live or substantially in real-time. For example, the secondary contest may be a “reality-based” television show in which the remaining contestants 16 and/or their designees 17 participate in various contests and/or voting against each other to determine one or more winning contestant 16. If some embodiments, system 10 may provide markets for buying, selling, or otherwise trading remaining eligible contest entries 14 during the secondary portion of the contest. In addition, system 10 may provide markets to the betting public so that they may wager on the results of one or more particular contests, such as, for example, so that they may wager on the winning contest entry 14, contestant 16, or designee 17 in a particular contest, or wager on whether a particular contest entry 14, contestant I 6, or designee 17 will win the overall multi-stage contest.

In an alternative embodiment, each (one or more) contest entry 14 remaining eligible after a particular number of stages, or after the number of eligible contest entries 14 falls within the particular threshold at step 108, is determined to be a winning contest entry 14. Thus, in such embodiments, the multiple-stage contest may not include a secondary portion including competitions between remaining contestants 16.

At step 114, one or more winning contest entries 14 or contestants 16 is determined, based on the results of the secondary portion of the contest at step 112, or in an alternative embodiment, each of the one or more contest entries 14 remaining eligible after a particular number of stages is determined to be a winning contest entry.

At step 116, an award pool 80 is determined from which awards may be provided to the one or more winning contest entries 14. The award pool 80 may include at least a portion of the revenues collected from the original selling of contest entries 14. In some cases, the award pool 80 may also include a portion of revenues generated by broadcasting the secondary portion of the contest, such as revenues associated with television broadcast or advertising, for example. A commission for providing and managing the contest may be determined and removed from the award pool 80. The commission may be a particular monetary amount or a particular percentage of the award pool 80.

At step 118, awards are provided to each of the one or more winning contestants 16 (or owners of winning contest entries 14) from the award pool 80. Awards may be provided to winning contestants 16 in any suitable manner, such as lump-sum cash awards or a number of installment payments over a period of time, for example.

Although an embodiment of the invention and its advantages are described in detail, a person skilled in the art could make various alterations, additions, and omissions without departing from the spirit and scope of the present invention as defined by the appended claims.

1. A method of providing a multiple-stage contest, comprising:
at each of a plurality of stages in a contest, causing a portion of a plurality of contest entries eligible to win the contest to become ineligible to win the contest; and
determining at least one winning contest entry from one or more contest entries remaining eligible after the plurality of stages.
